(19) United States
(12) Patent Application Publication
(10) Pub. No.: US 2011/0110071 A1
(43) Pub. Date: May 12, 2011

(54) RADIAL LIGHT-EMITTING DIODE LAMP IN FLAT PRINTED CIRCUIT BOARD FORM FACTOR

(75) Inventor: William D. Little, JR., Corinth, TX (US)

(73) Assignee: The Brinkman Corporation, Dallas, TX (US)

(21) Appl. No.: 12/875,852

(22) Filed: Sep. 3, 2010

Related U.S. Application Data
(60) Provisional application No. 61/239,710, filed on Sep. 3, 2009.

(51) Int. Cl. F21V 9/16; F21S 4/00

(52) U.S. Cl. 362/84; 362/249.02

(57) ABSTRACT

The present invention is embodied in a radial light-emitting diode (“LED”) lamp in a flat printed circuit hoard (“PCB”) form factor. In one embodiment, the LED lamp comprises a single, two-sided PCB having one or more LEDs on each side of the PCB. Each LED is encapsulated within a casing generally shaped as a linear dome or half cylinder having an axis. The casing may be a substantially homogenous, molded phosphor mixture that emits light upon exposure to the electromagnetic radiation emitted by the LED inside the casing. Because of phosphorescence and surface reflections in the casing, each LED emits light through an angle greater than 180 degrees transverse to the axis of the casing.

### CROSS-REFERENCE TO RELATED APPLICATION

The present application claims priority to U.S. Provisional Application No. 61/239,710, entitled “Radial Light-Emitting Diode Lamp in Flat Printed Circuit Board Form Factor,” filed Sep. 3, 2009, the entire contents of which are herein incorporated by reference.

### FIELD OF THE INVENTION

The present invention pertains to the field of light-emitting diode (“LED”) lamps.

### BACKGROUND OF THE INVENTION

LED-based illumination systems, including LED-based illumination systems for outdoor low-voltage lighting, have commonly included one or more LEDs contained within a housing capable of transmitting electromagnetic radiation from the LED(s) in the form of visible light. By varying the semiconductor materials used in the LED(s) and/or by adding a phosphor material to the housing, a variety of light colors may be produced, including white light, amber light, and yellow light.

Historically, LED lamps have been directional light sources, meaning that they do not approximate a “point source” of light (like an incandescent light bulb), but rather have a lambertian distribution. As a result, LED lamps have commonly been used in applications for which a linear light source is appropriate, such as status indicators on equipment and lighted signs.

In linear lighting, a cluster of LEDs is commonly arranged on a planar printed circuit board (“PCB”). Typically, an array of 5-millimeter LEDs is arranged on the PCB. A reflector or lens may cover the LED cluster. The PCB comprises a base portion that connects the PCB to a source of electrical current. Historically, bases having a “bi-pin” configuration or a “wedge” configuration have been used. A bi-pin base has two small pins extending from the PCB. A wedge base has two electrical contacts printed onto the PCB.

Although an LED cluster might suffice in applications for which a linear light source is appropriate, it is less than optimal for applications in which a point source of light is needed. An LED cluster looks like a cluster of LEDs, not a point source. As a result, using an LED cluster can cause multiple shadowing and imaging effects.

Efforts have been made to create omnidirectional LED lamps. One way that this has been accomplished is by positioning three PCBs in an equilateral triangle configuration, each PCB having an LED oriented at a 120-degree angle to the other LEDs. Another way that this has been accomplished is by positioning four PCBs in a square configuration, such that the LEDs are oriented at 90-degree angles. A further way that this has been accomplished is by positioning mirrors or other reflective surfaces to reflect the radiation emitted by an LED in multiple directions. All of these approaches are undesirably expensive and have resulted in multiple shadowing and imaging effects. None approximates a point source of light.

An alternate option has been to make a lamp using traditional plastic leaded chip carrier (PLCC) style SMD (surface-mounted device) LEDs. Again, this has resulted in multiple shadowing and imaging effects and the potential for dark rings in a simple two-sided array.

Accordingly, there is a need for a cost-effective approach to creating an omnidirectional, 360-degrees LED lamp that approximates a point source of light and mimics the effect of a light bulb filament, with limited or no shadowing or imaging effects. The present invention satisfies this and other needs, and provides further related advantages.

### SUMMARY OF THE INVENTION

The present invention is embodied in a radial LED lamp in a flat PCB form factor. In one embodiment, the LED lamp comprises a single, two-sided PCB having one or more LEDs on each side of the PCB. Each LED is encapsulated within a casing generally shaped as a linear dome or half cylinder having an axis. The casing may be a substantially homogenous, molded phosphor mixture that emits light upon exposure to the electromagnetic radiation emitted by the LED inside the casing. Because of phosphorescence and surface reflections in the casing, each LED emits light through an angle greater than 180 degrees transverse to the axis of the casing.

In one embodiment, the lamp comprises a printed circuit board defining a plane and having a first side and a second side; a first light emitting diode mounted on the first side of the printed circuit board; a second light emitting diode mounted on the second side of the printed circuit board opposite the first light emitting diode; a first casing mounted on the first side of the printed circuit board over the first light emitting diode; and a second casing mounted on the second side of the printed circuit board over the second light emitting diode. Each casing is configured to refract a portion of the light emitted by its associated light emitting diode toward the plane of the printed circuit board.

Each casing may comprise a phosphor mixture configured to phosphoresce upon exposure to the light emitted by the associated light emitting diode. In one embodiment, the phosphor mixture is dispersed throughout each casing. In another embodiment, the phosphor mixture is coated on an outside surface of each casing.

In a further embodiment, each casing is substantially shaped as a half cylinder having an axis. The casings are aligned so that their axes extend substantially parallel to each other on opposite sides of the printed circuit board. The printed circuit board has a width proximate the casings no greater than approximately five times the diameter of each casing. In a particular embodiment, the diameter of each casing is approximately 2 millimeters; and the width of the printed circuit board proximate the casings is no greater than approximately 10 millimeters.

In yet a further embodiment, the lamp further comprises a third light emitting diode mounted on the first side of the printed circuit board proximate to the first light emitting diode; a fourth light emitting diode mounted on the second side of the printed circuit board opposite the third light emitting diode; a third casing mounted on the first side of the printed circuit hoard over the third light emitting diode; and a fourth casing mounted on the second side of the printed circuit board over the fourth light emitting diode. In a particular embodiment, each casing is substantially shaped as a half cylinder; the first and third casings are aligned end-to-end along a first common axis; and the second and fourth casings are aligned end-to-end along a second common axis.

Other features and advantages of the invention will become apparent from the following detailed description of the preferred embodiments taken with the accompanying drawings, which illustrate, by way of example, the principles of the invention.

### BRIEF DESCRIPTION OF THE DRAWINGS

Embodiments of the present invention will now be described, by way of example only, with reference to the following drawings.

FIGS. 1A-1B are views of an LED lamp having a bi-pin base and one LED per side, in accordance with an embodiment of the present invention. FIG. 1A is a front elevation view. FIG. 1B is a rear elevation view.

FIGS. 2A-2D are diagrammatic views of the solder mask and traces for the LED lamp of FIGS. 1A-1B, in accordance with an embodiment of the present invention. FIG. 2A is a front view of the solder mask and print. FIG. 2B is a rear view of the solder mask and print. FIG. 2C is a front view of the traces. FIG. 2D is a rear view of the traces.

FIG. 3 is a side cross-sectional view of the LED lamp of FIGS. 1A-1B, taken along the plane indicated by the line a-a in FIG. 1A.

FIGS. 4A-4B are views of an LED lamp having a wedge base and one LED per side, in accordance with an embodiment of the present invention. FIG. 4A is a front elevation view. FIG. 4B is a rear elevation view.

FIGS. 5A-5B are views of an LED lamp having a wedge base and two LEDs per side, in accordance with an embodiment of the present invention. FIG. 5A is a front elevation view. FIG. 5B is a rear elevation view.

### DETAILED DESCRIPTION OF THE PREFERRED EMBODIMENTS

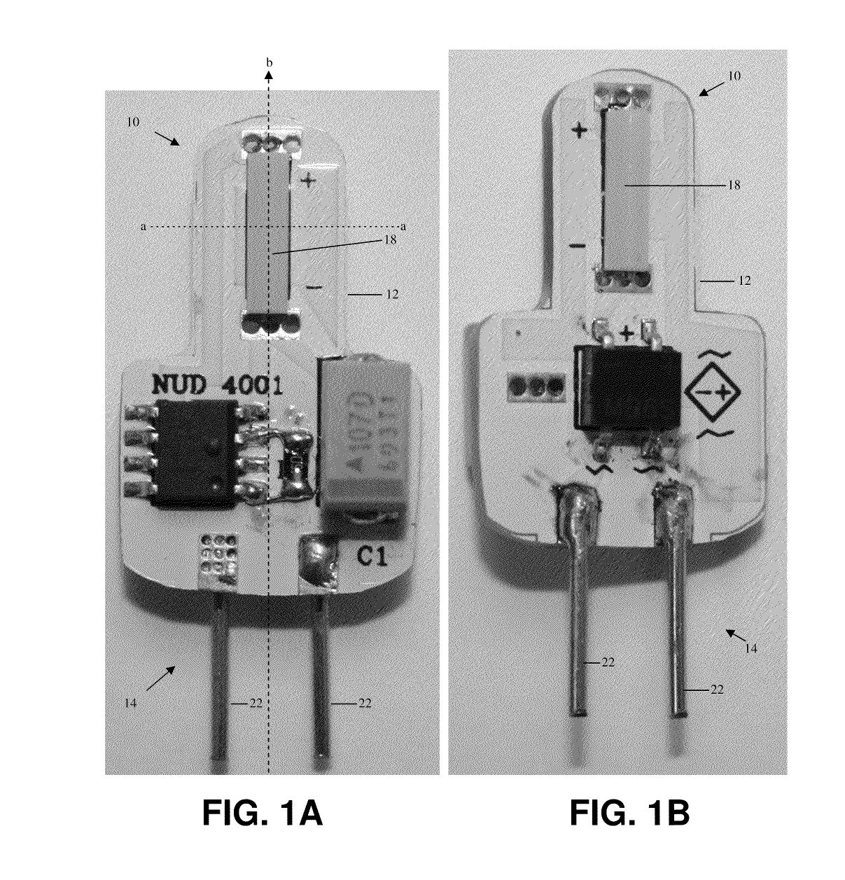

Referring now to the drawings, and particularly to FIGS. 1A-1B thereof, there is shown an LED lamp 10 comprising a single, two-sided PCB 12 having a hi-pin base 14 and one LED 16 on each side of the PCB, in accordance with an embodiment of the present invention. Each

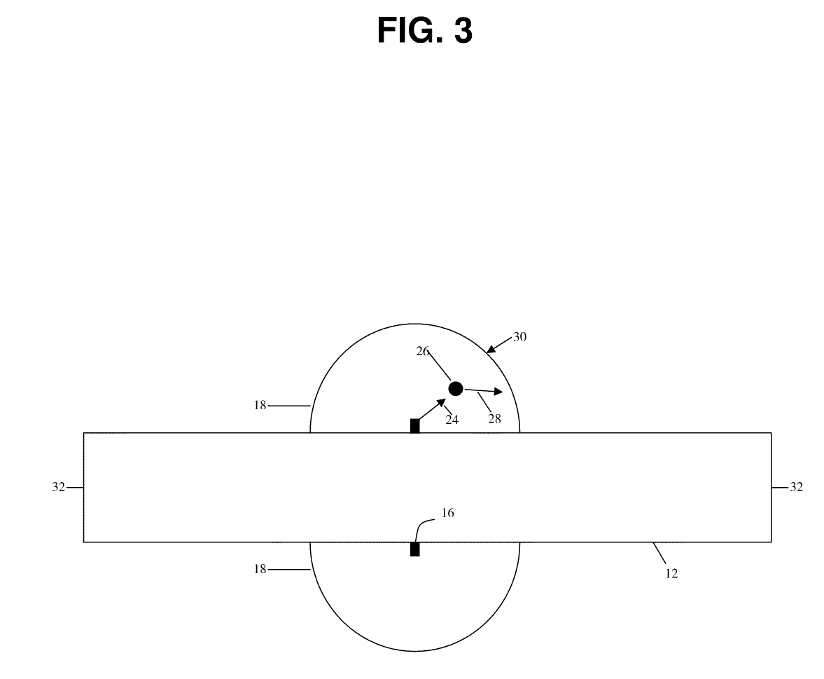

LED 16 (see FIG. 3) is encapsulated within a casing 18 generally shaped as a linear dome or half cylinder having an axis “b.” Each casing comprises a substantially homogenous, molded phosphor mixture that emits light upon exposure to electromagnetic radiation emitted by the LED inside the casing.

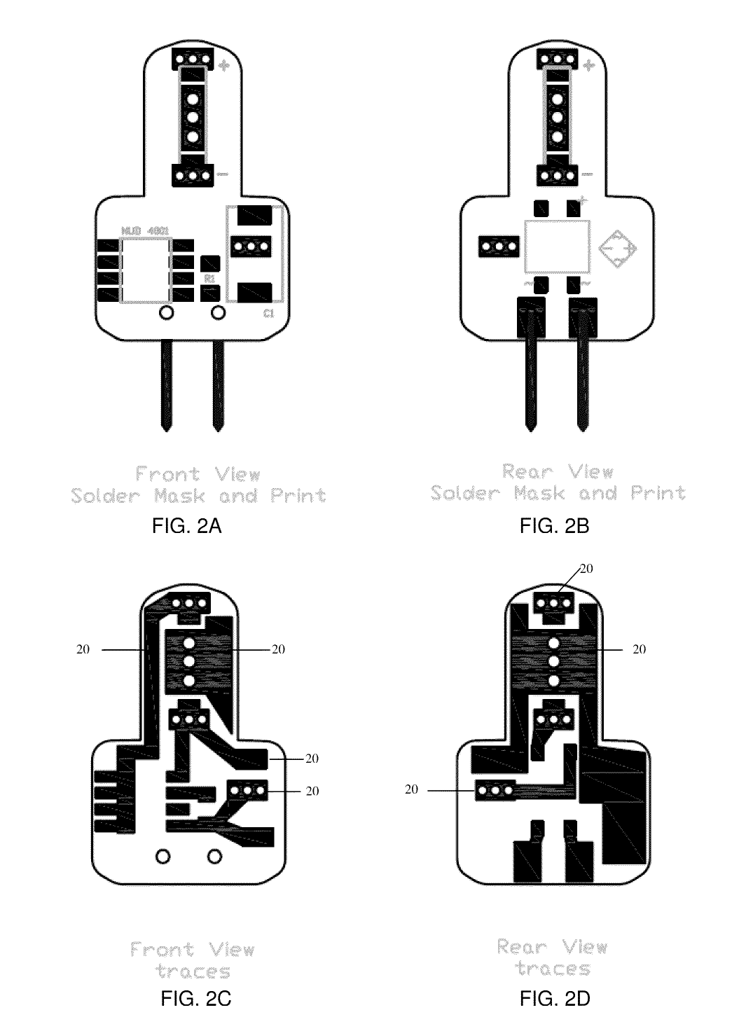

The PCB 12 mechanically supports the LEDs 16 and electrically connects them to the hi-pin base 14 via conductive pathways or traces 20 (see FIGS. 2C-2D), which may be etched from copper sheets laminated onto a non-conductive substrate. In one embodiment, the PCB comprises a dielectric substrate having a conformal coating to provide weather resistance and inhibit corrosion. The conformal coating may comprise a solution of silicone rubber, polyurethane, acrylic, epoxy, and/or another suitable material known in the art.

The bi-pin base 14 comprises two small pins 22 extending from the PCB 12 and spaced approximately 4 millimeters to approximately 8 millimeters apart. The pins may be soldered onto the PCB. In one embodiment, the hi-pin base complies with a standard from the International Electrotechnical Commission for lamp fittings, so that the lamp 10 can fit into existing lamp receptacles.

To produce white light, the LED 16 can be a blue LED that emits a dark blue light. The phosphor casing 18 absorbs at least some of the light from the blue LED and re-emits it in a broad range of wavelengths. In one embodiment, the casing encapsulates InGaN blue LEDs inside of a substantially homogenous phosphor mold. A suitable phosphor material for the casing is cerium-doped yttrium aluminium garnet (Ce³⁺:YAG). In one embodiment, the phosphor is dispersed throughout the casing, rather than being coated on the outside surface of the casing.

The LEDs 16 and associated casings 18 are positioned opposite each other on the two-sided PCB 12. In one embodiment, each casing is approximately 8 millimeters long and approximately 2 millimeters wide. The casings are aligned so that their axes extend parallel to each other.

With reference to FIGS. 2A-2D, there are shown diagrammatic views of the traces 20 and solder mask for the LED lamp 10, in accordance with an embodiment of the present invention. FIG. 2A is a front view of the solder mask and print. FIG. 2B is a rear view of the solder mask and print. FIG. 2C is a front view of the traces. FIG. 2D is a rear view of the traces.

In one embodiment, the LED lamp 10 is manufactured with 4-ounce copper traces etched onto an FR-4 (woven glass and epoxy) PCB substrate having a thickness of approximately two millimeters. The FR-4 substrate may be overmolded to improve strength and/or UV-stabilized with a tetrafunctional expoxy resin system. In one embodiment, a white solder mask is applied over the traces to provide a protective coating for the copper traces and to reflect light that might impinge upon the PCB. In other embodiments, other materials for the PCB substrate may be used, including FR-2 (phenolic cotton paper), FR-3 (cotton paper and epoxy), FR-5 (woven glass and epoxy), FR-6 (matte glass and polyester), G-10 (woven glass and epoxy), CEM-1 (cotton paper and epoxy), CEM-2 (cotton paper and epoxy), CEM-3 (woven glass and epoxy), CEM-4 (woven glass and epoxy), and CEM-5 (woven glass and polyester), ceramic, and/or metal.

In a further embodiment, the LEDs 16 are Everlight C-17 3500K LEDs made by Everlight Electronics Co., Ltd. of Taipei, Taiwan. The LEDs may be driven by an ON Semiconductor NUD4001 DR2G high-current LED driver made by ON Semiconductor of Phoenix, Ariz. The LED lamp 10 may also comprise a Diodes HD04 0.8A surface-mount glass-passivated bridge rectifier made by Diodes Inc. of Dallas, Tex.; a Vishay 293D107X9020E2TE3 solid tantalum surface mount capacitor (20V, 100 μF) made by Vishay Intertechnology, Inc. of Malvern, Pa.; and an 0805-size, ⅛ W, 16-ohm resistor.

With reference to FIG. 3, there is shown a side cross-sectional view of the LED lamp 10 illustrating the operation of the lamp in accordance with an embodiment. In operation, the LEDs 16 emit rays of dark blue light (represented by photons 24) into the phosphor casings 18. Phosphor particles 26 dispersed throughout the phosphor casings absorb at least some of the photons 24 and emit photons 28 in random directions. At least some of the photons 28 emitted by the phosphor particles will eventually reach the surfaces 30 of the phosphor casings, where the light will reflect and refract in further directions because the refractive index of the phosphor casings differs from the refractive index of air. These surface reflections and refractions, combined with the phosphorescence of the phosphor particles, allow each LED to emit light through an angle greater than 180 degrees transverse to the axis of the associated phosphor casing. Because the LED lamp comprises two LEDs, one on each side of the PCB 12, the lamp is configured to emit light through a full 360 degrees with limited or no shadowing or imaging effects.

In some embodiments, some or all of the photons 24 may reach the surface 30 of the phosphor casing 18 without being absorbed by a phosphor particle 26. In some embodiments, some or all of the photons 28 may be absorbed and emitted by the phosphor particles multiple times before reaching the surface of the phosphor casing.

As shown in FIG. 3, the PCB 12 is wider than the phosphor casings 18 so that there is sufficient surface area on the PCB to convey heat away from the LEDs 16. This causes some of the light transmitted through the phosphor casings to impinge upon the PCB. The width “w” of the PCB is preferably calibrated so that a significant portion of the light transmitted through the phosphor casings at an angle greater than 180 degrees is allowed to pass unimpeded beyond the PCB to create an overlapped field proximate the edge 32 of the PCB. In one embodiment, the width “w” of the PCB is no wider than approximately five times the width of the individual LEDs 16, which provides sufficient surface area to convey heat away from the LEDs while allowing sufficient light to pass unimpeded beyond the PCB. Preferably, each casing is approximately 2 millimeters wide and the PCB is no wider than approximately 10 millimeters. More preferably, the PCB is no wider than approximately 6 to 8 millimeters. Most preferably, the PCB is approximately 7 millimeters wide.

Using a 7-millimeter-wide PCB, it has been found that the PCB is sufficiently narrow to allow an LED contained within a 2-millimeter-wide phosphor casing to emit light through an angle of approximately 240 degrees transverse to the axis of the casing. By placing two such LEDs and casings directly opposite each other on the two sides of the PCB, 360-degree illumination can be achieved.

The present invention thus can be configured to provide a cost-effective means of producing a point-source effect from LEDs placed upon a single flat PCB, with limited or no shadowing or imaging effects. The LED lamp may be configured to be placed inside a glass, plastic, or fused quartz envelope having a standard E26 (MES) base configured to fit in a standard light bulb socket.

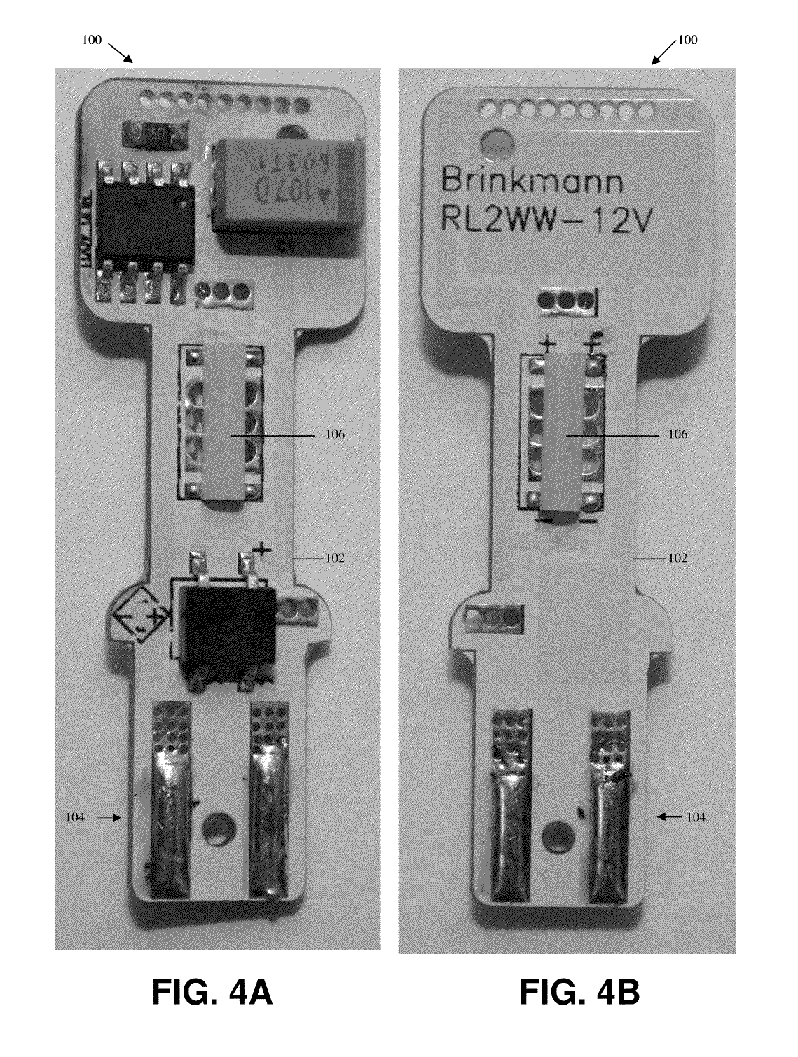

With reference to FIGS. 4A-4B, there are shown views of an LED lamp 100 comprising a single, two-sided PCB 102 having a wedge base 104 and one LED on each side of the PCB, in accordance with an embodiment of the present invention. Each LED is encapsulated within a casing 106 generally shaped as a linear dome or half cylinder. As with the bi-pin embodiment of FIGS. 1A-1B, each casing comprises a substantially homogenous, molded phosphor mixture that emits light upon exposure to electromagnetic radiation emitted by the LED inside the casing. Aside from the base configuration and the arrangement of the circuit elements on the PCB, the structure and operation of the two-LED wedge embodiment or FIGS. 4A-4B is substantially the same as the structure and operation of the bi-pin embodiment of FIGS. 1A-1B.

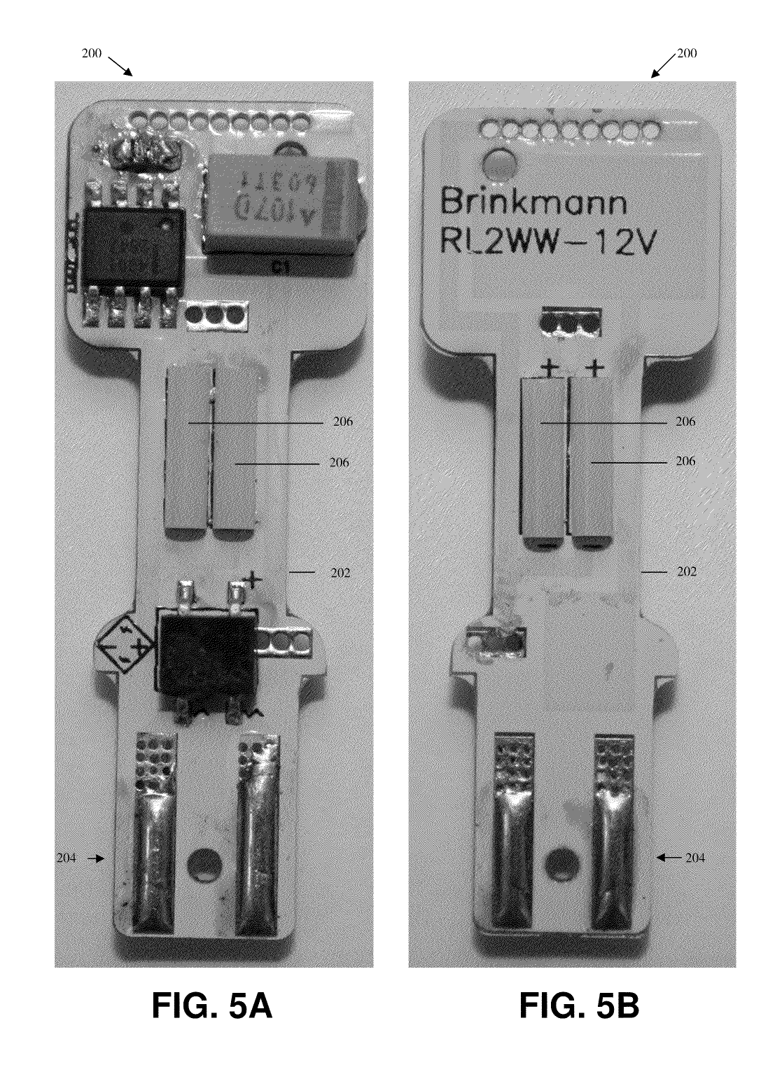

With reference to FIGS. 5A-5B, there are shown views of an LED lamp 200 comprising a single. two-sided PCB 202 having a wedge base 204 and two LEDs on each side of the PCB, in accordance with an embodiment of the present invention. Each LED is encapsulated within a casing 206 generally shaped as a linear dome or half cylinder. As with the bi-pin embodiment of FIGS. 1A-1B and the two-LED wedge embodiment of FIGS. 4A-4B. each casing comprises a substantially homogenous, molded phosphor mixture that emits light upon exposure to electromagnetic radiation emitted by the LED inside the casing. Aside from the base configuration, the arrangement of the circuit elements on the PCB, and use of two additional LEDs, the structure and operation of the four-LED wedge embodiment of FIGS. 5A-5B is substantially the same as the structure and operation of the bi-pin embodiment of FIGS. 1A-1B and the two-LED wedge embodiment of FIGS. 4A-4B.

In addition to the bi-pin embodiment of FIGS. 1A-1B, the two-LED wedge embodiment of FIGS. 4A-4B, and the four-LED wedge embodiment of FIGS. 5A-5B, there are other embodiments for which the present invention is applicable. In one embodiment, the LED lamp comprises more than two LEDs on each side of the PCB. In this embodiment, the phosphor casings may be positioned end-to-end in a linear configuration to create a tubular source effect. In another embodiment, the PCB is a multiple-layer board and the traces run between the layers. In this embodiment, the PCB can be made narrower, since the traces do not run on the outside surfaces of the board.

The present invention has been described above in terms of presently preferred embodiments so that an understanding of the present invention can be conveyed. However, there are other embodiments not specifically described herein for which the present invention is applicable. Therefore, the present invention should not to be seen as limited to the forms shown, which is to be considered illustrative rather than restrictive.

What is claimed is:

1. A lamp comprising:
a printed circuit board defining a plane and having a first side and a second side;
a first light emitting diode mounted on the first side of the printed circuit hoard;
a second light emitting diode mounted on the second side of the printed circuit board opposite the first light emitting diode;
a first casing mounted on the first side of the printed circuit board over the first light emitting diode; and
a second casing mounted on the second side of the printed circuit board over the second light emitting diode,
wherein each casing is configured to refract a portion of the light emitted by its associated light emitting diode toward the plane of the printed circuit board.

2. The lamp of claim 1, wherein each casing comprises a phosphor mixture configured to phosphoresce upon exposure to the light emitted by the associated light emitting diode.

3. The lamp of claim 2, wherein the phosphor mixture is dispersed throughout each casing.

4. The lamp of claim 2, wherein the phosphor mixture is coated on an outside surface of each casing.

5. The lamp of claim 1, wherein each casing is substantially shaped as a half cylinder having an axis; and the casings are aligned so that their axes extend substantially parallel to each other on opposite sides of the printed circuit board.

6. The lamp of claim 5, wherein the printed circuit board has a width proximate the casings no greater than approximately five times the diameter of each casing.

7. The lamp of claim 6, wherein the diameter of each casing is approximately 2 millimeters; and the width of the printed circuit board proximate the casings is no greater than approximately 10 millimeters.

8. The lamp of claim 1, further comprising:
a third light emitting diode mounted on the first side of the printed circuit board proximate to the first light emitting diode;
a fourth light emitting diode mounted on the second side of the printed circuit board opposite the third light emitting diode;
a third casing mounted on the first side of the printed circuit board over the third light emitting diode; and
a fourth casing mounted on the second side of the printed circuit board over the fourth light emitting diode.

9. The lamp of claim 8, wherein each casing is substantially shaped as a half cylinder; the first and third casings are aligned end-to-end along a first common axis; and the second and fourth casings are aligned end-to-end along a second common axis.

10. A lamp comprising:
a printed circuit board having a first side and a second side;
a first light emitting diode mounted on the first side of the printed circuit board;
a second light emitting diode mounted on the second side of the printed circuit board opposite the first light emitting diode;
a first casing mounted on the first side of the printed circuit board over the first light emitting diode; and
a second casing mounted on the second side of the printed circuit hoard over the second light emitting diode,
wherein each casing comprises a phosphor mixture configured to phosphoresce upon exposure to the light emitted by the associated light emitting diode.

11. The lamp of claim 10, wherein the phosphor mixture is dispersed throughout each casing.

12. The lamp of claim 10, wherein the phosphor mixture is coated on an outside surface of each casing.

13. The lamp of claim 10, wherein each casing is substantially shaped as a half cylinder having an axis; and the casings are aligned so that their axes extend substantially parallel to each other on opposite sides of the printed circuit board.

14. The lamp of claim 13, wherein the printed circuit board has a width proximate the casings no greater than approximately five times the diameter of each casing.

15. The lamp of claim 14, wherein the diameter of each casing is approximately 2 millimeters; and the width of the printed circuit board proximate the casings is no greater than approximately 10 millimeters.

16. The lamp of claim 10, further comprising:
a third light emitting diode mounted on the first side of the printed circuit board proximate to the first light emitting diode;
a fourth light emitting diode mounted on the second side of the printed circuit board opposite the third light emitting diode;
a third casing mounted on the first side of the printed circuit board over the third light emitting diode; and
a fourth casing mounted on the second side of the printed circuit board over the fourth light emitting diode.

17. The lamp of claim 16, wherein each casing is substantially shaped as a half cylinder; the first and third casings are aligned end-to-end along a first common axis; and the second and fourth casings are aligned end-to-end along a second common axis.

18. A lamp comprising:
a printed circuit board having a first side and a second side;
a first light emitting diode mounted on the first side of the printed circuit board;
a second light emitting diode mounted on the second side of the printed circuit board opposite the first light emitting diode;
a first casing mounted on the first side of the printed circuit board over the first light emitting diode; and
a second casing mounted on the second side of the printed circuit board over the second light emitting diode,
wherein each casing is substantially shaped as a half cylinder having an axis; and
wherein the casings are aligned so that their axes extend substantially parallel to each other on opposite sides of the printed circuit board.

19. The lamp of claim 18, wherein each casing comprises a phosphor mixture configured to phosphoresce upon exposure to the light emitted by the associated light emitting diode.

20. The lamp of claim 19, wherein the phosphor mixture is dispersed throughout each casing.

21. The lamp of claim 19, wherein the phosphor mixture is coated on an outside surface of each casing.

22. The lamp of claim 18, wherein the printed circuit board has a width proximate the casings no greater than approximately five times the diameter of each casing.

23. The lamp of claim 22, wherein the diameter of each casing is approximately 2 millimeters; and the width of the printed circuit hoard proximate the casings is no greater than approximately 10 millimeters.

24. The lamp of claim 18, further comprising:
a third light emitting diode mounted on the first side of the printed circuit board proximate to the first light emitting diode;
a fourth light emitting diode mounted on the second side of the printed circuit board opposite the third light emitting diode;
a third casing mounted on the first side of the printed circuit board over the third light emitting diode; and
a fourth casing mounted on the second side of the printed circuit board over the fourth light emitting diode.

25. The lamp of claim 24, wherein each casing is substantially shaped as a half cylinder; the first and third casings are aligned end-to-end along a first common axis; and the second and fourth casings are aligned end-to-end along a second common axis.
